(19) United States
(12) Patent Application Publication
(10) Pub. No.: US 2012/0104855 A1
(43) Pub. Date: May 3, 2012

(54) UN-INTERRUPTIBLE POWER SUPPLY SYSTEM

(76) Inventors: CHING-NAN YANG, Taipei City (TW); Tsung-Chih Kao, New Taipei City (TW); Chun-Hsin Yang, New Taipei City (TW)

(21) Appl. No.: 13/022,596

(22) Filed: Feb. 7, 2011

(30) Foreign Application Priority Data
Oct. 29, 2010 (TW) 099220975

(51) Int. Cl. H02J 9/00

(52) U.S. Cl. 307/64

(57) ABSTRACT

The un-interruptible power supply system mainly contains an electricity detection device and a power supplying module. The electricity detection diction is connected to the in-house wiring and detects the state of electricity on the in-house wiring. If abnormality is detected, a wireless transmitter in the electricity detection device would radiate a wireless signal indicating such an abnormality. A wireless receiver in the power supplying module would receive the wireless signal and thereby activate auxiliary power provisioning. As such, the present invention is able to accurately maintain product operation as long as the power provisioning from the in-house wiring is normal, and to sustain the power provisioning precisely when there is a black out.

### (a) TECHNICAL FIELD OF THE INVENTION

The present invention is generally related to un-interruptible power provisioning, and more particularly to an un-interruptible power supply system having an electricity detection device transmitting a wireless signal to activate a power supplying module in an electronic device.

### (b) DESCRIPTION OF THE PRIOR ART

As shown in FIG. 1, a conventional un-interruptible power supply system contains an electricity detection device 40 and a power supplying module 42. The electricity detection device 40 detects if electricity on a power cable 41 is normal and, if yes, transmits a wireless signal through a wireless transmitter 401. On the other hand, the power supplying module 42 contains a wireless receiver 421 for the reception of the wireless signal from the wireless transmitter 401. As long as the wireless receiver 421 is located within the radio coverage of the wireless transmitter 401, the wireless receiver 421 would continuously receive the wireless signal continuously radiated from the wireless transmitter 401. Therefore, when the wireless receiver 421 frails to receive the wireless signal, the power supplying module 42 activates a power supplying device to maintain normal power provisioning so that the interruption of electricity on the power cable 41 do not affect any device operation.

However, due to environmental or other factors, the wireless receiver 421 might miss some wireless signal while the wireless transmitter 401 continuously radiating the wireless signal. As such, the wireless receiver 421 might mistakenly trigger the power supplying device while there is no power interruption.

### SUMMARY OF THE INVENTION

As such, a major objective of the present invention is to accurately maintain product operation as long as the power provisioning from the in-house wiring is normal, and to sustain the power provisioning precisely when there is a black out.

To achieve this objective, the present invention mainly contains an electricity detection device and a power supplying module. The electricity detection diction is connected to the in-house wiring and detects the state of electricity on the in-house wiring. If abnormality is detected, a wireless transmitter in the electricity detection device would radiate a wireless signal indicating such an abnormality. A wireless receiver in the power supplying module would receive the wireless signal and thereby activate auxiliary power provisioning.

Another objective of the present invention is to keep the original in-house wiring intact and to provide the un-interruptible power provisioning at the same time.

Yet another objective of the present invention is that a same lamp could function both for ordinary lighting and emergency lighting. As such, there is no need to deploy separate lamps for emergency lighting and the in-house decoration could be more flexible.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a block diagram showing the major functional blocks of a conventional un-interruptible power supply system.

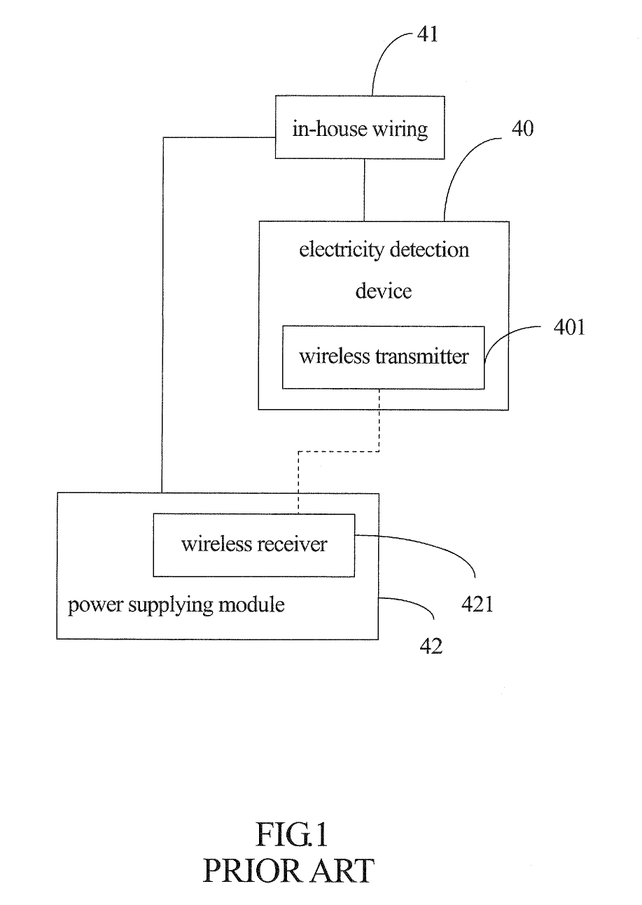

FIG. 2 is a block diagram showing the major functional blocks of an un-interruptible power supply system according to an embodiment of the present invention.

FIG. 3 is a flow diagram showing the un-interruptible power supply system of FIG. 2 utilizing electricity on the in-house wiring.

FIG. 4 is a flow diagram showing the un-interruptible power supply system of FIG. 2 not utilizing electricity on the in-house wiring.

FIG. 5 is a schematic diagram showing an application scenario of an un-interruptible power supply system according to another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

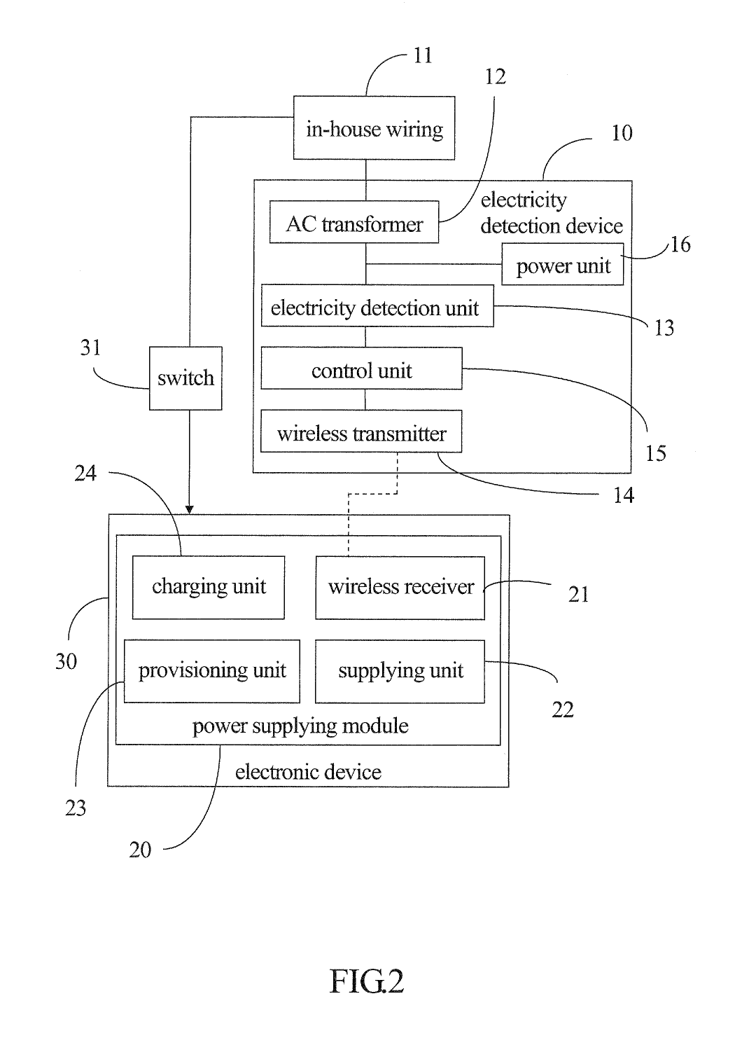

As illustrated in FIG. 2, an un-interruptible power supply system according to an embodiment of the present invention detects whether electricity is normal on an in-house wiring 11 and, if not, transmits a wireless signal to control a power supplying module 20. The un-interruptible power supply system further contains the following components.

An electricity detection device 10 is connected to the in-house wiring 11 through an AC transformer 12 which in turn is connected to an electricity detection unit 13. A control unit 15 receives an activation signal from the electricity detection unit 13 and transmits an activation signal to a wireless transmitter 14 for radiating the wireless signal. The electricity detection device 10 is powered by the electricity stored in a power unit 16 and the stored electrical energy is capable of allowing the wireless transmitter 14 to radiate the wireless signal when abnormality on the in-house wiring 11 is detected. The wireless signal is then received by a wireless receiver 21 of the power supplying module 20.

The power supplying module 20 is for powering an electronic device 30 such as a lamp or any electronic product requiring un-interruptible power provisioning. The power supplying module 20 contains the following components.

A provisioning unit 23 is electrically connected to the wireless receiver 21 and activates a supplying unit 22 to supply electricity to the electronic device 30.

A charging unit 24 forms an electrical loop with the supplying unit 22 so as to maintain the electricity supply from the supplying unit 22.

The electronic device 30 is electrically connected to a switch 31 for establishing and breaking the connection of the electronic device 30 to the in-house wiring 11. The wireless transmitter 14 has a radio coverage covering at least a wireless receiver 21 of a power supplying module 20.

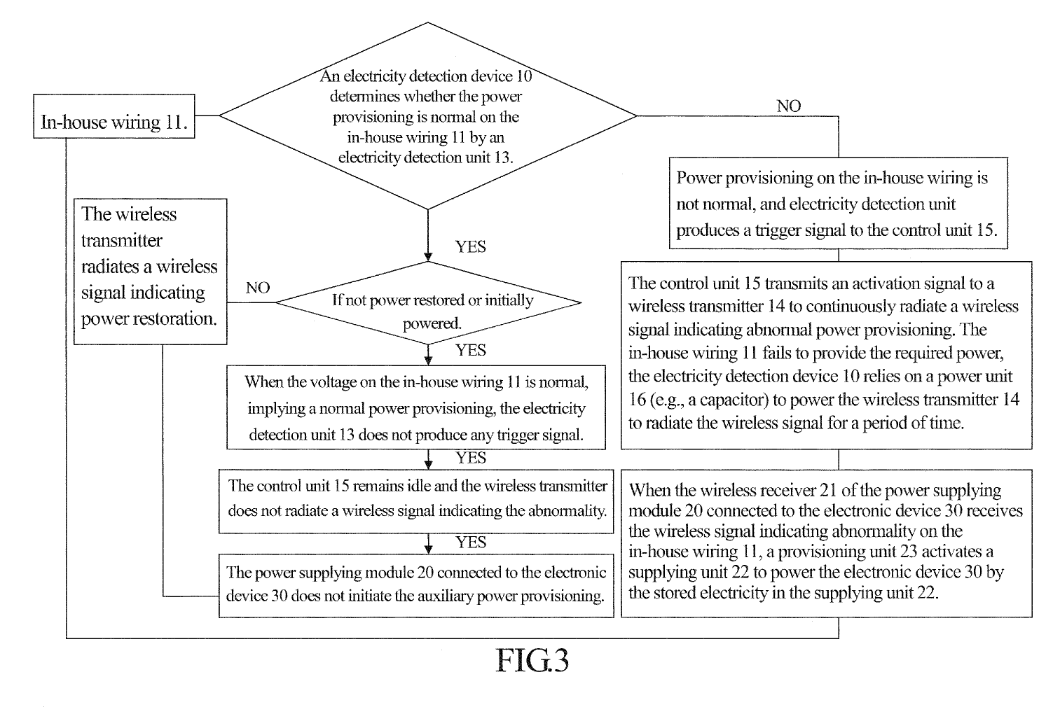

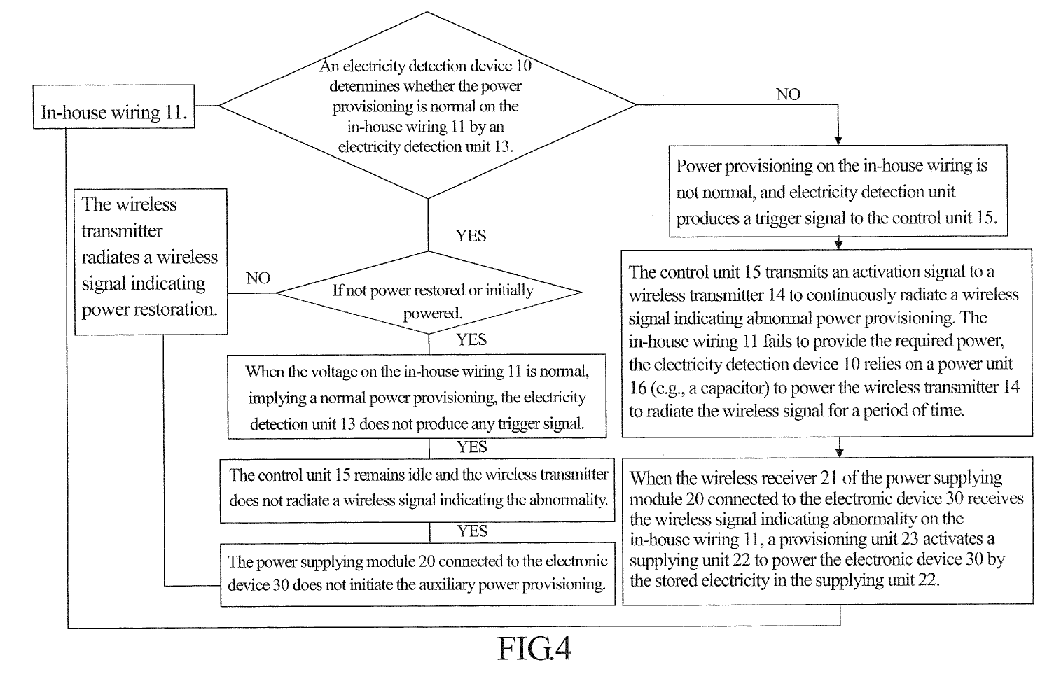

FIGS. 3 and 4 provide two scenarios of the un-interruptible power supply system. As illustrated, the electricity detection device 10 detects whether the electricity on the in-house wiring 11 is normal by the electricity detection unit 13. When the voltage on the in-house wiring 11 is normal, implying a normal power provisioning, the electricity detection unit 13 does not produce any trigger signal and the control unit 15 remains idle. The wireless transmitter 14 therefore does not radiate a wireless signal indicating the abnormality (however, when power provisioning is restored or power is initially provisioned, a wireless signal is issued). As such, the power supplying module 20 connected to the electronic device 30 does not initiate the auxiliary power provisioning. In the mean time, the charging unit 24 is activated to charge and maintain the stored electricity of the supplying unit 22. On the other hand, if the switch 31 is turned off, the charging unit 24 is not activated to charge the supplying unit 22.

When the electricity on the in-house wiring is not present or detected to be abnormal, the electricity detection unit 13 produces an trigger signal to the control unit 15, which in turn issue an activation signal to the wireless transmitter 14. Since the in-house wiring 11 at the moment fails to provide the required power, the electricity detection device 10 relies on the power unit 16 (e.g., a capacitor) to power the wireless transmitter 14 to radiate the wireless signal for a period of time. For how long the wireless transmitter 14 is able to continuously function depends on the design of the power unit 16.

When the wireless receiver 21 of the power supplying module 20 connected to the electronic device 30 receives the wireless signal indicating abnormality on the in-house wiring 11, the provisioning unit 23 activates the supplying unit 22 to power the electronic device 30 by the stored electricity in the supplying unit 22.

With the foregoing arrangement, the un-interruptible power supply system is able to maintain the operation of the electronic device 30 when in-house wiring 11 offers normal power provisioning and when there is a black out.

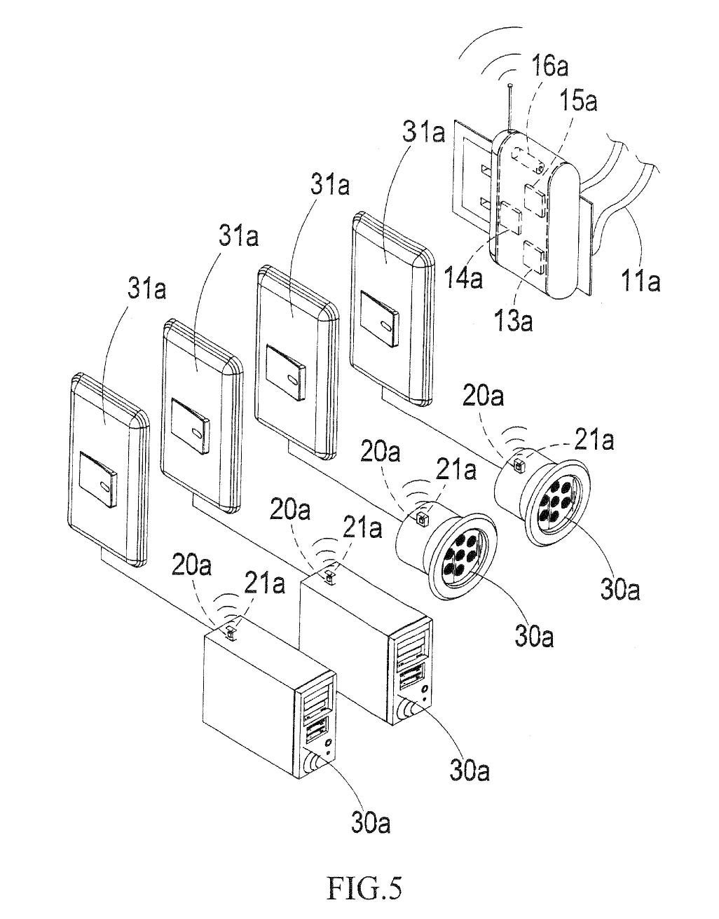

As shown in FIG. 5, another embodiment of the present invention utilizes a rechargeable battery as the power unit 16. Each electronic device 30a is series-connected to a switch 31a. When abnormality is detected on the in-house wiring 11a, the electricity detection unit 13a produces an trigger signal to the control unit 15a, which in turn issues an activation signal to the wireless transmitter 14a. Since the in-house wiring 11a fails to provide the required power, the power unit 16a powers the wireless transmitter 14a to radiate the wireless signal for a period of time whose duration depends on the design of the power unit 16a.

When the power supplying module 20a of the electronic device 30a receives the wireless signal indicating abnormality through the wireless receiver 21a, the electronic device 30a (such as a lamp or a computer) is continuously powered.

The power unit 16a could also be a one-time battery for temporarily powering the wireless transmitter 14a to transmit the wireless signal.

The present invention has the following advantages.

First of all, when there is black out, the wireless transmitter 14 is able to continuously function by the power unit 16 without problem.

The chance of missing the wireless signal is significantly reduced and the electronic device 30 is prevented from being mistakenly activated.

When the in-house wiring 11 provides normal power provisioning, the wireless transmitter 14 is refrained from continuously radiating wireless signal to the wireless receiver 21 (except when electricity is restored or when electricity is initially supplied) so as to reduce power consumption.

The present invention is able to keep the original in-house wiring intact while achieving un-interruptible power supply.

The wireless signal could be radiated to multiple electronic devices 30 so that all the power supplying modules 20 of these electronic devices 30 could be notified and activated simultaneously.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An un-interruptible power supply system comprising:
an electricity detection device connected to an in-house wiring having a wireless transmitter radiating a wireless signal, a power unit with stored electricity to power said electricity detection device and said wireless transmitter when said in-house wiring fails to power said electricity detection device; and
a power supplying module having a wireless receiver for receiving said wireless signal from said wireless transmitter.

2. The un-interruptible power supply system according to claim 1, wherein said electricity detection device further contains an electricity detection unit detecting whether said in-house wiring offers normal power provisioning; and a control unit receives an trigger signal from said electricity detection unit and produces an activation signal to said wireless transmitter.

3. The un-interruptible power supply system according to claim 1, wherein said power supplying module further contains a supplying unit, a provisioning unit electrically connected to said wireless receiver and activates said supplying unit to supply electricity, and a charging unit forms an electrical loop with said supplying unit so as to maintain the electricity supply from said supplying unit.

4. The un-interruptible power supply system according to claim 1, wherein at least a wireless receiver of a power supplying module is located within a radio coverage of said wireless transmitter.

5. The un-interruptible power supply system according to claim 1, wherein said power supplying module is series-connected to said in-house wiring via a switch.

6. The un-interruptible power supply system according to claim 1, wherein said power supplying module is connected to an electronic device to provide auxiliary power provisioning.

7. The un-interruptible power supply system according to claim 6, wherein said electronic device is one of a lamp and a device requiring un-interruptible power provisioning.
